(19) United States
(12) Patent Application Publication
(10) Pub. No.: US 2008/0112497 A1
(43) Pub. Date: May 15, 2008

(54) Apparatus and method for providing relay service in an OFDM mobile communication system

(75) Inventors: Cheng Shan, Suwon-si (KR); Young-Bin Chang, Anyang-si (KR); Pan-Yuh Joo, Seoul (KR); Chang-Yoon Oh, Yongin-si (KR); Eun-Taek Lim, Suwon-si (KR); Soon-Mi Cho, Seoul (KR); Jinxia Cheng, Beijing (CN)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 11/985,069

(22) Filed: Nov. 13, 2007

(30) Foreign Application Priority Data
Nov. 13, 2006 (KR) 2006-0111537

(51) Int. Cl. H04K 1/10

(52) U.S. Cl. 375/260

(57) ABSTRACT

An apparatus and method for providing a relay service in an OFDM mobile communication system are provided, in which symbol synchronization is acquired from a received OFDM signal, an OFDM signal is acquired using the symbol synchronization, and a relay signal is reconfigured by removing a cyclic prefix from the acquired OFDM signal, amplifying the relay signal, and transmitting the relay signal.

### CROSS-REFERENCE TO RELATED APPLICATION AND CLAIM OF PRIORITY

The present application claims the benefit under 35 U.S.C. §119(a) of a Korean Patent Application filed in the Korean Intellectual Property Office on Nov. 13, 2006 and assigned Serial No. 2006-111537, the entire disclosure of which is hereby incorporated by reference.

### TECHNICAL FIELD OF THE INVENTION

The present invention generally relates to an orthogonal frequency division multiplexing (OFDM) mobile communication system. More particularly, the present invention relates to an apparatus and method for synchronizing a received relay signal, regenerating a cyclic prefix (CP), amplifying a relay signal reconfigured with the regenerated CP, and forwarding the amplified relay signal to a next-hop relay station (RS) in an OFDM mobile communication system.

### BACKGROUND OF THE INVENTION

Relay stations are added to an OFDM mobile communication system in order to increase data rate and expand coverage. A message from a source station is delivered to a destination station via a relay station (RS). That is, one or more RSs relay a message from the source station to the destination station by multiple hops. The source station and the destination can be a base station (BS) or a mobile station (MS).

A radio channel between hops is affected by multipath fading. Line-of-sight (LOS) transmission is blocked by obstacles, especially in a downtown environment, and thus the signal is reflected. Due to this propagation reflection, a receiver receives a combination of copies of reflected signals. The characteristics of a multipath channel are explained by impulse response. The channel impulse response of the radio channel appears to be pulses with different delays because of the multipath reflection. The resulting time dispersion causes frequency selective fading to the radio channel. The frequency selective fading is a radio propagation anomaly that takes place when the correlation bandwidth of the channel is narrower than the bandwidth of the channel. In this case, fading characteristics vary within the bandwidth of the channel. The correlation bandwidth refers to the bandwidth of the channel when the channel has a correlation equal to or greater than a predetermined value with respect to another channel spaced from the channel by a predetermined distance.

The OFDM mobile communication system uses a cyclic prefix (CP) to mitigate the effects of multipath delay. An OFDM transmitter creates a CP in the time domain by copying a tail portion of an Inverse Fast Fourier Transform (IFFT) signal. An OFDM receiver first removes the CP from the signal received from the OFDM transmitter prior to Fast Fourier Transform (FFT). If a maximum delay from the source station to the destination station is less than a CP length, the CP is not affected by a time-dispersed fading channel. However, since the relay station (RS) simply amplifies the received OFDM signal and forwards it to a next-hop RS, the CP of an OFDM symbol relayed over multiple hops becomes shorter than the maximum delay. As a result, inter-symbol interference (ISI) is induced. With reference to FIG. 1, ISI caused by time delay during an OFDM symbol relay in a two-hop OFDM mobile communication system will be described, by way of example.

FIG. 1 illustrates an OFDM symbol relaying mechanism in a two-hop OFDM mobile communication system.

Referring to FIG. 1, a source station 101 transmits an OFDM signal to a destination station 103 via an RS 102. The OFDM signal is transmitted on two fading channels 107 and 109 with delay profiles 108 and 110, respectively. The maximum delays of the profiles 108 and 110 do not exceed a CP within the respective radio channels. The OFDM signal transmitted from the source station 101 is divided into two parts, data symbols 104a and 106a and a CP 105a (CP1) being a copy of a predetermined tail portion of the data symbol 106a.

With respect to the OFDM signal transmitted on the fading channel 107 with the delay profile 108, the OFDM signal received in the RS 102 has a CP 105b (CP1) distorted by the previous OFDM symbol 104b.

The RS 102 amplifies the received OFDM signal and forwards it to the destination station 103 on the fading channel 109 with the delay profile 110. The destination station 103 receives an OFDM signal in which a data symbol 106c as well as a CP 105c (CP1) are distorted by the previous data symbol 104c. The accumulation of the time delays of the fading channels 107 and 109 enough to be larger than the length of the CP 105a accounts for the distortion.

In a conventional multi-hop mobile communication system with relay stations using an amplify-and-forward (AF) strategy, when a relay station (RS) simply amplifies a received OFDM signal and forwards it to a next-hop RS, the time dispersion of a frequency selective radio channel is accumulated at each hop and a destination station eventually receives an OFDM signal with a CP length shorter than a maximum time delay. The resulting overlap between received signals causes signal distortion. In other words, as a signal is relayed over more hops, a larger ISI results, thus distorting a signal.

Accordingly, there exists a need for an apparatus and method for reducing the distortion of an OFDM symbol relayed over multiple hops.

### SUMMARY OF THE INVENTION

To address the above-discussed deficiencies of the prior art, it is a primary object of the present invention to address at least the problems and/or disadvantages and to provide at least the advantages described below. Accordingly, an aspect of the present invention is to provide an apparatus and method for reducing inter-symbol interference (ISI) during relaying a message in a multi-hop OFDM mobile communication system.

Another aspect of the present invention is to provide an apparatus and method for preventing propagation of the time dispersion of multiple channels at each hop during relaying a message in a multi-hop OFDM mobile communication system.

A further aspect of the present invention is to provide an apparatus and method for removing an old cyclic prefix (CP) and regenerating a new CP during relaying a message in a multi-hop OFDM mobile communication system.

In accordance with an aspect of exemplary embodiments of the present invention, there is provided a relaying method in an OFDM mobile communication system, in which symbol synchronization is acquired from a received OFDM signal, an OFDM signal is acquired using the symbol synchronization, and a relay signal is reconfigured by removing a CP from the acquired OFDM signal, amplified, and transmitted.

In accordance with another aspect of exemplary embodiments of the present invention, there is provided a relay station (RS) in an OFDM mobile communication system, in which a synchronizer acquires symbol synchronization from a received OFDM signal, a CP regenerator acquires an OFDM signal using the symbol synchronization and reconfigures a relay signal by removing a CP from the acquired OFDM signal, and an amplifier amplifies the relay signal and transmits the amplified relay signal.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an OFDM symbol relaying mechanism in a conventional two-hop OFDM mobile communication system;

FIGS. 2A and 2B illustrate the configuration of a multi-hop OFDM mobile communication system according to an embodiment of the present invention;

FIG. 3 is a block diagram of an RS in the multi-hop OFDM mobile communication system according to an embodiment of the present invention;

FIG. 4 illustrates an OFDM symbol relaying mechanism in a two-hop OFDM mobile communication system according to an embodiment of the present invention;

FIG. 5 is a flowchart of a message relaying operation in the multi-hop OFDM mobile communication system according to an embodiment of the present invention; and

FIGS. 6A, 6B and 6C are graphs illustrating results of first, second and third simulations according to embodiments of the present invention.

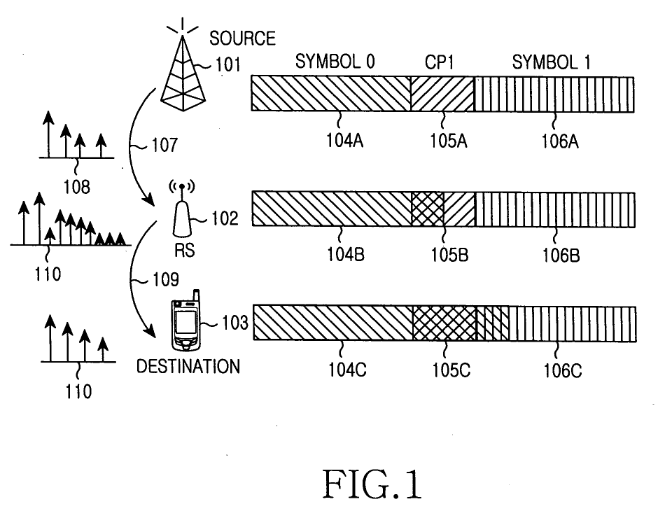

Throughout the drawings, the same drawing reference numerals will be understood to refer to the same elements, features and structures.

### DETAILED DESCRIPTION OF THE INVENTION

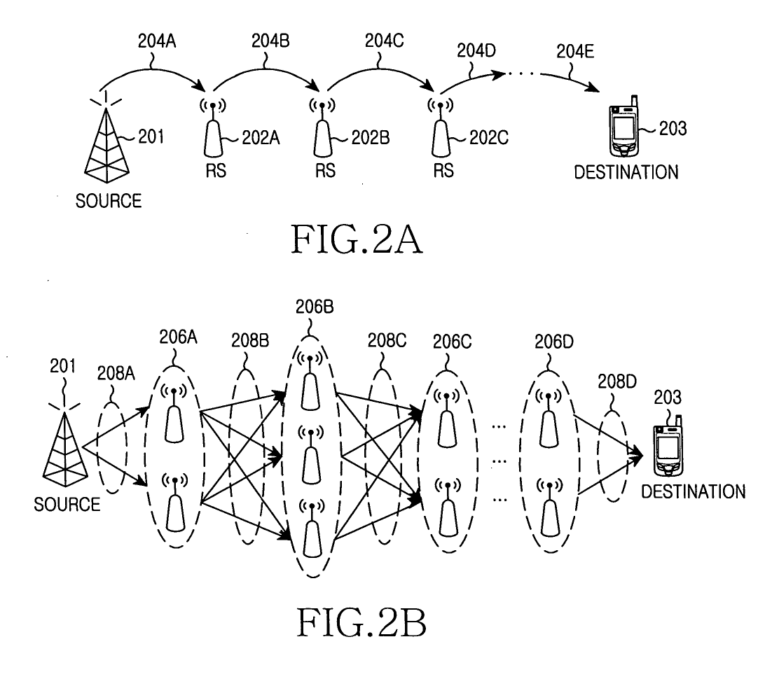

FIGS. 2A through 6C, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless network.

The matters defined in the description such as a detailed construction and elements are provided to assist in a comprehensive understanding of embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The present invention provides an apparatus and method for synchronizing a received relay signal, regenerating a cyclic prefix (CP), amplifying a relay signal reconfigured with the regenerated CP, and forwarding the amplified relay signal to a next-hop relay station (RS) in an OFDM mobile communication system.

The following description is made on the assumption that an OFDM symbol duration and a cyclic prefix (CP) length are preset during a relay call negotiation among a source, a destination, and relay stations (RSs). Therefore, each RS has prior knowledge of the OFDM symbol duration and the CP length. It is also assumed that cyclic prefixes are of the same length for all sources, destinations, and relay stations.

Since the CP length depends on a maximum delay from a current relay group to a next relay group, it is set according to the maximum delay. It is assumed that a maximum delay between every pair of RSs is known.

FIGS. 2A and 2B illustrate the configuration of a multi-hop OFDM mobile communication system according to an embodiment of the present invention.

Referring to FIGS. 2A and 2B, messages are transmitted from a source station 201 to a destination station 203 via a plurality of RSs 202a to 202c and 206a to 206c over multiple hops in the multi-hop OFDM mobile communication system. One RS forms a group in FIG. 2A and a plurality of relay stations (RSs) form a group in FIG. 2B. According to the present invention, the RSs 202a-c and 206a-c can detect OFDM signals from previous-hop RSs, amplify the analog OFDM signals, and forward the amplified OFDM signals to next-hop RSs. The RSs 202a-c and 206a-c are not equipped with a decoding or encoding function.

In FIG. 2A, each RS group 204a to 204e includes a single RS. The RS group receives a signal from the previous-hop RS (or a destination station 201) and then forwards it to the next-hop RS.

In FIG. 2B, each RS group 208a to 208d includes one or more RSs. The RS group receives signals from the previous-hop RS group and then forwards them to the next-hop RS group. A received signal of each RS within the RS group is a combination of signals received from all of the previous-hop RSs.

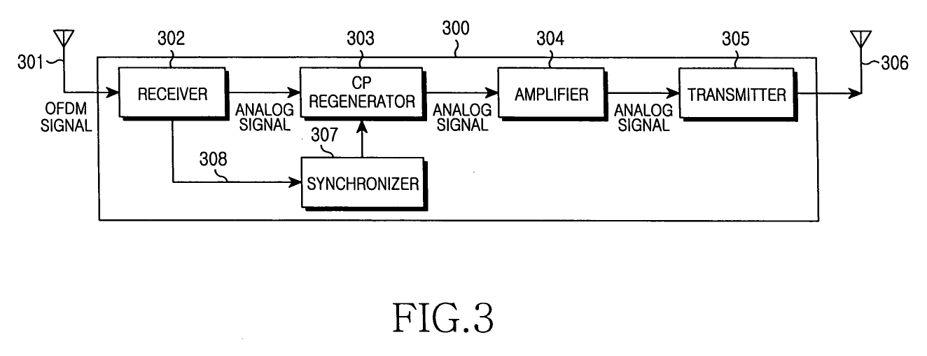

FIG. 3 is a block diagram of a relay station (RS) in the multi-hop OFDM mobile communication system according to an embodiment of the present invention.

Referring to FIG. 3, an RS 300 includes a receiver 302 with an OFDM receive antenna 301, a CP regenerator 303, an amplifier 304, a transmitter 305 with an OFDM transmit antenna 306, and a synchronizer 307.

The receiver 302 downconverts a Radio Frequency (RF) signal received through the OFDM receive antenna 301 to a baseband signal.

The synchronizer 307 acquires OFDM symbol synchronization from the baseband signal received from the receiver 302. The OFDM symbol synchronization is acquired from the analog baseband signal or baseband sample data in a known algorithm.

The CP regenerator 303 acquires an OFDM symbol signal from the baseband signal received from the receiver 302 according to synchronization information received from the synchronizer 307 and removes a CP from the OFDM symbol signal. Since the CP regenerator 303 can identify the start and end of the OFDM symbol signal in the time domain using the synchronization information, it can remove the CP of a predetermined length from the OFDM symbol signal. Then the CP regenerator 303 regenerates a CP by copying a tail portion of the predetermined CP length of the CP-free OFDM symbol signal and adds the regenerated CP to the CP-free OFDM symbol signal, thereby reconfiguring an OFDM signal.

The amplifier 304 amplifies the reconfigured OFDM signal. The transmitter 305 transmits the amplified OFDM signal to a destination station through the OFDM transmit antenna 306.

For reference, while the RS 300 does not perform OFDM demodulation, it can be further contemplated that it performs OFDM demodulation in a baseband.

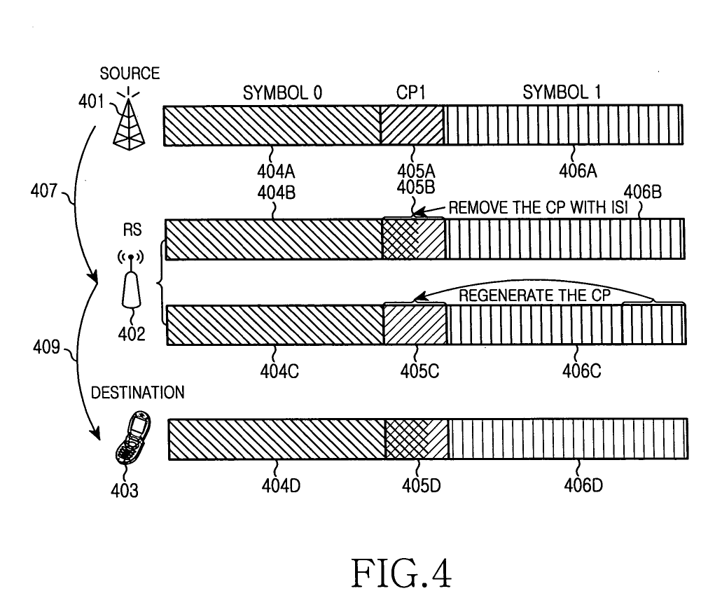

FIG. 4 illustrates an OFDM symbol relaying mechanism in a two-hop OFDM mobile communication system according to an embodiment of the present invention.

Referring to FIG. 4, a source station 401 transmits an OFDM signal to a destination station 403 via an RS 402.

The OFDM signal is transmitted on two fading channels 407 and 409 with the delay profiles 108 and 110, respectively. The OFDM signal transmitted from the source station 401 is divided into two parts, data symbols 404a and 406a and a CP 405a (CP1) being a copy of a predetermined tail portion of the data symbol 406a.

With respect to the OFDM signal transmitted on the fading channel 407 with the delay profile 108, the OFDM signal received in the RS 402 has a CP 405b (CP1) distorted by the previous OFDM symbol 404b. Thus, the RS 402 performs the following process according to the present invention.

The synchronization can be considered in two ways, analog synchronization and digital synchronization. In the analog synchronization, the RS 402 divides the received OFDM signal according to whether subcarriers are used or not, calculates the energies of the two signals, and acquires synchronization by detecting the start of a new frame based on the ratio between the energies of the two signals. In the digital synchronization, the RS 402 detecting the start of a new frame using a maximum correlation with respect to a reference signal. Then, the RS 402 reconfigures an OFDM signal by replacing the distorted inter-symbol interference (ISI)—including CP 405b—with a copy of a tail portion of a predetermined CP length of the data symbol 406b. The RS 402 amplifies the reconfigured OFDM signal and transmits the amplified OFDM signal to the destination station 403. Therefore, the delay of the fading channel 407 can be eliminated.

The reconfigured OFDM signal 404c, 405c and 406c from the RS 402 is transmitted on the fading channel 409 with the delay profile 110. The destination station 403 receives an OFDM signal with a CP 405d (CP1) distorted by the previous data symbol 404d. Since the RS 402 has already eliminated the delay of the previous delay profile 108, the destination station 403 has only the delay of the delay profile 110. As the delay of the delay profile 110 is shorter than the CP 405c, ISI is not induced.

In accordance with the present invention, the RS 402 cancels ISI caused from a previous OFDM symbol at each hop. Compared to a conventional RS with a simple AF function which sets a CP length for each hop to be longer than the sum of the maximum delays of channels, that is, the propagation delay from the source station to the destination station, the RS of the present invention sets a CP length taking into account only the propagation delay from one hop to another hop.

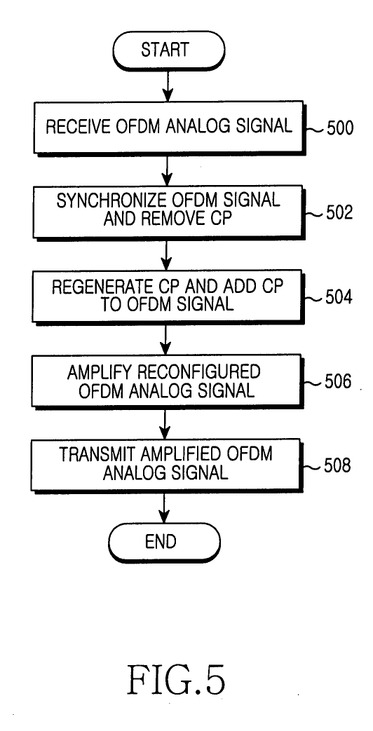

FIG. 5 is a flowchart of a message relaying operation in the multi-hop OFDM mobile communication system according to an embodiment of the present invention.

Referring to FIG. 5, the RS receives an analog OFDM signal from a previous-hop RS in step 500.

In step 502, the RS 402 detects the start and end of an OFDM symbol and the start of a CP by synchronizing the received OFDM signal and eliminates the CP from the synchronized OFDM signal. Since the RS 402 has prior knowledge of an OFDM symbol duration and a CP length, it can detects the start and end of the CP from the synchronized OFDM signal. The synchronization is carried out by one of the synchronization methods described with reference to FIG. 3.

The RS 402 regenerates a CP by copying a tail portion of a data symbol in the OFDM signal and reconfigures an OFDM signal by adding the regenerated CP to the position of the removed CP in step 504.

The RS 402 amplifies the reconfigured OFDM signal in step 506 and transmits the amplified OFDM signal to a next-hop RS in step 508.

Then, the RS 402 ends the OFDM relay procedure of the present invention.

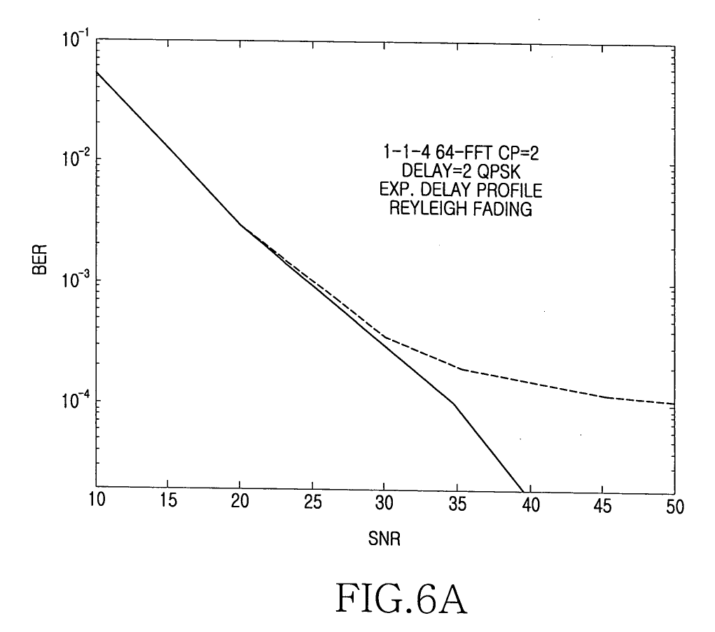

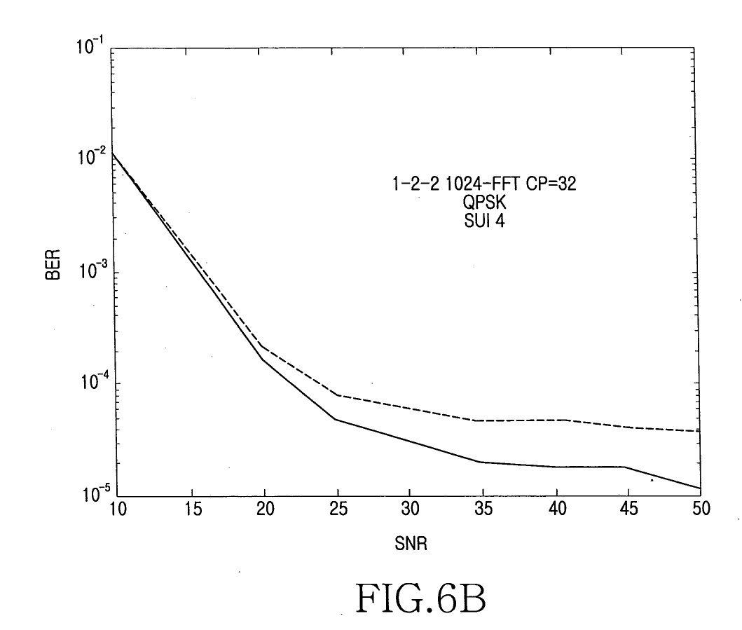

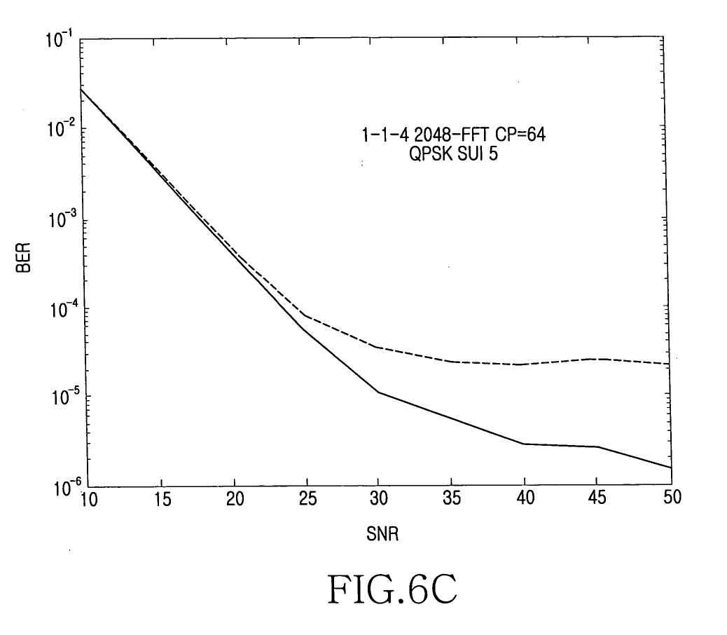

FIG. 6A is a graph illustrating results of a first simulation according to an embodiment of the present invention.

Referring to FIG. 6A, the present invention is compared with the conventional technology in terms of Bit Error Rate (BER) for a model of a two-hop mobile communication system having a transmitter with a single antenna, an RS with a single antenna, and a receiver with four antennas under a Rayleigh fading environment. Simulation conditions are that the receiver performs 64-point FFT and Quadrature Phase Shift Keying (QPSK), a delay is two symbols, and a CP length is two symbols.

FIG. 6B is a graph illustrating results of a second simulation according to another embodiment of the present invention.

Referring to FIG. 6B, the present invention is compared with the conventional technology in terms of BER for a model of a two-hop mobile communication system having a transmitter with a single antenna, an RS with two antennas, and a receiver with two antennas under a Stanford University Interim (SUI) 4 channel environment. Simulation conditions are that the receiver performs 1024-point FFT and QPSK and a CP length is 32 symbols.

FIG. 6C is a graph illustrating results of a third simulation according to a third embodiment of the present invention.

Referring to FIG. 6C, the present invention is compared with the conventional technology in terms of BER for a model of a two-hop mobile communication system having a transmitter with a single antenna, an RS with a single antenna, and a receiver with four antennas under an SUI 5 channel environment. Simulation conditions are that the receiver performs 2048-point FFT and QPSK and a CP length is 64 symbols.

As is apparent from the above description, the present invention synchronizes a received relay signal, regenerates a new CP by eliminating an old CP, reconfigures a relay signal with the new CP, amplifies the reconfigured relay signal, and transmits the amplified relay signal in an OFDM mobile communication system. Therefore, ISI that may be caused by multi-hop relaying is reduced.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A relaying method in an orthogonal frequency division multiplexing (OFDM) mobile communication system, the method comprising:
acquiring symbol synchronization from a received signal;
acquiring an OFDM signal using the symbol synchronization;
reconfiguring a relay signal by removing a cyclic prefix from the acquired OFDM signal; and
amplifying the relay signal and transmitting the amplified relay signal.

2. The relaying method of claim 1, wherein the symbol synchronization acquisition comprises acquiring the symbol synchronization from one of an analog signal and sample data.

3. The relaying method of claim 1, wherein the length of the cyclic prefix and the length of an OFDM symbol are predetermined during a relay call negotiation.

4. The relaying method of claim 1, wherein the length of the cyclic prefix is longer than a maximum delay between relay stations.

5. The relaying method of claim 1, wherein the reconfiguration comprises regenerating a cyclic prefix by a copy of a tail portion of a predetermined cyclic prefix (CP) length of an OFDM data symbol and adding the regenerated cyclic prefix at the position of the removed cyclic prefix.

6. The relaying method of claim 1, wherein the cyclic prefix depends on status of a radio channel with time dispersion.

7. The relaying method of claim 1, wherein the symbol synchronization acquisition comprises acquiring the symbol synchronization without OFDM demodulation.

8. The relaying method of claim 1, wherein the symbol synchronization acquisition comprises acquiring the symbol synchronization by performing OFDM demodulation in a baseband.

9. A relay station in an orthogonal frequency division multiplexing (OFDM) mobile communication system, the relay station comprising:
a synchronizer for acquiring symbol synchronization from a received signal;
a cyclic prefix (CP) regenerator for acquiring an OFDM signal using the symbol synchronization and reconfiguring a relay signal by removing a cyclic prefix from the acquired OFDM signal; and
an amplifier for amplifying the relay signal and transmitting the amplified relay signal.

10. The relay station of claim 9, wherein the synchronizer acquires the symbol synchronization from one of an analog signal and sample data.

11. The relay station of claim 9, wherein the length of the cyclic prefix and the length of an OFDM symbol are predetermined during a relay call negotiation.

12. The relay station of claim 9, wherein the length of the cyclic prefix is longer than a maximum delay between relay stations.

13. The relay station of claim 9, wherein the CP regenerator reconfigures the relay signal by regenerating a cyclic prefix by a copy of a tail portion of a predetermined cyclic prefix (CP) length of an OFDM data symbol and adding the regenerated cyclic prefix at the position of the removed cyclic prefix.

14. The relay station of claim 9, wherein the cyclic prefix depends on status of a radio channel with time dispersion.

15. The relay station of claim 9, wherein the synchronizer acquires the symbol synchronization without OFDM demodulation.

16. The relay station of claim 9, wherein the synchronizer acquires the symbol synchronization by performing OFDM demodulation in a baseband.

17. A relay station in an orthogonal frequency division multiplexing (OFDM) mobile communication system, adapted to perform:
i) acquiring symbol synchronization from a received OFDM signal,
ii) acquiring an OFDM signal using the symbol synchronization,
iii) reconfiguring a relay signal by removing a cyclic prefix from the acquired OFDM signal,
iv) amplifying the relay signal, and
v) transmitting the amplified relay signal.

18. The relay station of claim 17, wherein the relay station acquires the symbol synchronization from one of an analog signal and sample data.

19. The relay station of claim 18, wherein the length of the cyclic prefix and the length of an OFDM symbol are predetermined during a relay call negotiation.

20. The relay station of claim 19, wherein the length of the cyclic prefix is longer than a maximum delay between relay stations.
